(19) United States
(12) Patent Application Publication
(10) Pub. No.: US 2026/0122133 A1
(43) Pub. Date: Apr. 30, 2026

(54) CONTROL DEVICE, CONTROL SYSTEM, AND METHOD

(71) Applicant: KABUSHIKI KAISHA TOSHIBA, Kawasaki-shi (JP)

(72) Inventors: Takahiro YAMAURA, Sagamihara (JP); Masashi ITO, Kawasaki (JP); Yuta KOBAYASHI, Ota (JP)

(73) Assignee: KABUSHIKI KAISHA TOSHIBA, Kawasaki-shi (JP)

(21) Appl. No.: 19/314,587

(22) Filed: Aug. 29, 2025

(30) Foreign Application Priority Data
Oct. 30, 2024 (JP) 2024-190703

(51) Int. Cl. H04L 67/12; H04L 67/60

(52) U.S. Cl. CPC H04L 67/12; H04L 67/60

(57) ABSTRACT

According to one embodiment, a control device executing processing for controlling an edge device is provided. The control device includes a processor configured to generate capability information indicating capability of the control device, which can be provided under conditions specified in relation to the processing, and transmit the generated capability information.

### CROSS-REFERENCE TO RELATED APPLICATIONS

This application is based upon and claims the benefit of priority from Japanese Patent Application No. 2024-190703, filed Oct. 30, 2024, the entire contents of which are incorporated herein by reference.

### FIELD

Embodiments described herein relate generally to a control device, a control system, and a method.

### BACKGROUND

In recent years, control systems configured to remotely control edge devices have become known. In such a control system, for example, real-time processing (processing requiring real-time performance) may be executed. To achieve such real-time processing, it is desirable to utilize an edge cloud in the control system.

The edge cloud is an information processing device configured to provide cloud computing services to edge devices. Since information can be processed at positions close to the edge devices as compared to the public cloud which are available widely and generally through the Internet or the like, real-time performance can be ensured.

In the edge cloud, however, installation and operational costs are often higher than those in the public cloud.

For this reason, it is necessary to improve the functional accommodation efficiency by efficiently operating the control system and reduce the number of edge clouds (information processing devices) to be installed and operated.

### BRIEF DESCRIPTION OF THE DRAWINGS

FIG. 1 is a diagram showing an example of a network configuration of a control system according to an embodiment.

FIG. 2 is a diagram showing an example of a functional configuration of a communication transfer device in a comparative example of the present embodiment.

FIG. 3 is a diagram showing an example of a functional configuration of an information processing device in the comparative example of the present embodiment.

FIG. 4 is a diagram showing an example of a functional configuration of an orchestration device in the comparative example of the present embodiment.

FIG. 5 is a table showing an example of gate control information.

FIG. 6 is a table showing an example of scheduling information.

FIG. 7 is a diagram showing an example of a functional configuration of a communication transfer device according to the present embodiment.

FIG. 8 is a diagram showing an example of a functional configuration of an information processing device according to the present embodiment.

FIG. 9 is a diagram showing an example of a functional configuration of an orchestration device according to the present embodiment.

FIG. 10 is a flowchart showing an example of the processing for generating first and second operation control information.

FIG. 11 is a diagram illustrating a relationship between a control cycle and a response time.

### DETAILED DESCRIPTION

In general, according to one embodiment, a control device for executing processing for controlling an edge device is provided. The control device includes a processor configured to generate capability information indicating capability of the control device, which can be provided under conditions specified in relation to the processing, and transmit the generated capability information.

Various embodiments will be described with reference to the accompanying drawings.

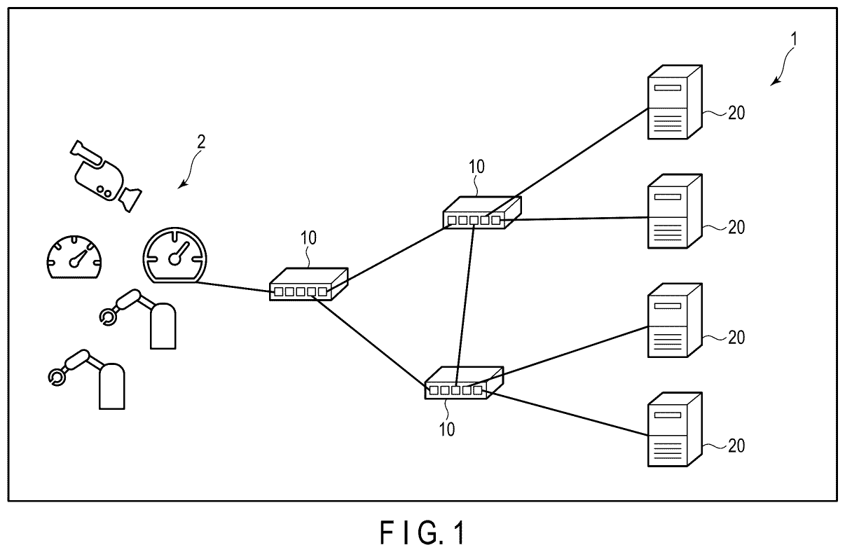

FIG. 1 shows an example of a network configuration of a control system according to the present embodiment. In the example shown in FIG. 1, a control system 1 includes a plurality of communication transfer devices 10 and a plurality of information processing devices 20. Incidentally, in the example shown in FIG. 1, a plurality of communication transfer devices 10 and a plurality of information processing devices 20 are shown. However, each of the number of communication transfer devices 10 and the number of information processing devices 20 may be at least one or more.

In the present embodiment, at least one of the plurality of communication transfer devices 10 is connected to at least one of the plurality of edge devices 2, and the plurality of communication transfer devices 10 are communicably connected to each other. In addition, each of the plurality of information processing devices 20 is communicably connected to at least one of the plurality of communication transfer devices 10.

The control system 1 according to the present embodiment corresponds to, for example, an Internet of Things (IoT) system and operates to control the plurality of edge devices 2 by transmitting and receiving frames between the plurality of information processing devices 20 and the plurality of edge devices 2 via the plurality of communication transfer devices 10.

In this case, the plurality of communication transfer devices 10 are realized as, for example, network switches (relay devices) and the like, and execute network processing such as transferring frames within the control system 1. For example, the switches may be Layer 2 switches (bridges) that transfer frames at Layer 2, i.e., the data link layer, or Layer 3 switches (routers) that transfer packets at Layer 3.

The plurality of information processing devices 20 execute computational processing (information processing) for controlling the plurality of edge devices 2 by, for example, executing application programs stored in a memory using a central processing unit (CPU) or the like. Incidentally, the plurality of information processing devices 20 may be realized as, for example, edge clouds that provide cloud computing services to (users using) the plurality of edge devices 2. When realized as edge clouds, the plurality of information processing devices 20 are located at not remote positions such as the public cloud, but positions close to (users using) the plurality of edge devices 2.

The plurality of edge devices 2 correspond to IoT devices and include, for example, field equipment such as robot arms operating in factories or the like. Incidentally, the plurality of edge devices 2 may also be sensor devices, cameras, or the like for monitoring the operating status or abnormalities of various facilities located in factories and the like or may be other devices.

Although not shown in FIG. 1, the control system 1 according to the present embodiment further includes an orchestration device. The orchestration device generates, for example, operation control information (hereinafter referred to as first operation control information) specifying the operations of each of the communication transfer devices 10 and operation control information (hereinafter referred to as second operation control information) specifying the operations of each of the information processing devices 20.

In this case, the plurality of communication transfer devices 10 operate in accordance with the first operation control information generated by the orchestration device, and the plurality of information processing devices 20 operate in accordance with the second operation control information generated by the orchestration device.

Incidentally, the plurality of communication transfer devices 10 and the plurality of information processing devices 20 described above correspond to the control devices provided in the control system 1 according to the present embodiment. In addition, the above-described orchestration device may also correspond to the control device.

A comparative example of the present embodiment will be described below before describing details of the control system 1 according to the present embodiment. Incidentally, the network configuration of the control system according to the comparative example of the present embodiment is assumed to be the same as that shown in FIG. 1. Therefore, the control system according to the comparative example of the present embodiment will also be described below with reference to FIG. 1.

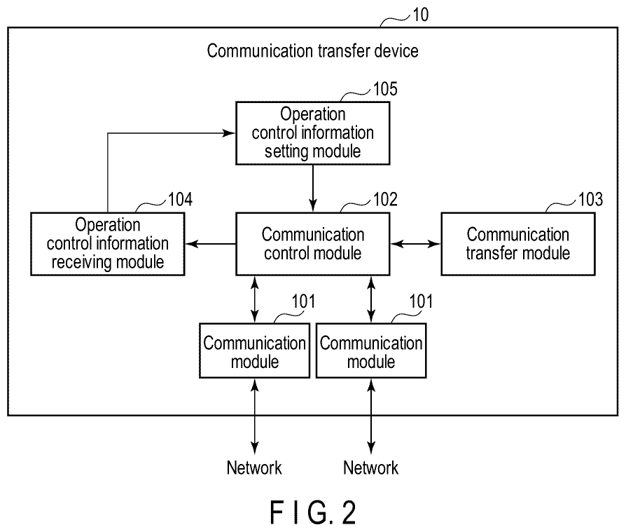

FIG. 2 shows an example of the functional configuration of the communication transfer device in the comparative example of the present embodiment. As shown in FIG. 2, the communication transfer device 10 includes communication modules 101, a communication control module 102, a communication transfer module 103, an operation control information receiving module 104, and an operation control information setting module 105.

The communication modules 101 receive frames transmitted from, for example, the edge device 2 or the information processing devices 20 that are capable of communicating with the communication transfer device 10. The frames transmitted from the edge device 2 include device data obtained at the edge device 2. Incidentally, the device data is data related to the edge device 2 and includes, for example, sensor data and the like. The frames transmitted from the information processing devices 20 include data corresponding to results of the computational processing executed by the information processing devices 20.

In addition, the communication modules 101 receive frames transmitted from the orchestration device. The frames transmitted from the orchestration device include the first operation control information generated by the orchestration device.

The frames received by the communication modules 101 may be frames transmitted (transferred) from other communication transfer devices 10.

The communication modules 101 transmit (transfer) the received frames to the edge device 2 that is capable of communicating with the communication transfer device 10, other communication transfer devices 10, or the information processing devices 20.

Incidentally, the communication modules 101 execute, for example, processing for communication using protocols such as Ethernet (registered trademark) and the like. More specifically, the communication modules 101 execute processing at data link layers and physical layers of an OSI reference model, and realize functions referred to as Media Access Controller (MAC) and PHY.

Furthermore, the communication modules 101 shown in FIG. 2 are provided for respective communication ports of the communication transfer device 10. More specifically, the communication transfer device 10 includes a communication module 101 corresponding to a communication port connected to a device corresponding to the frame transfer source (for example, edge device 2) and a communication module 101 corresponding to a communication port connected to a device corresponding to the frame transfer destination (for example, the other communication transfer device 10 or information processing devices 20). In addition, the communication transfer device 10 may include a communication module 101 corresponding to a communication port connected to the orchestration device.

The communication control module 102 controls the operations of the communication transfer device 10, based on the first operation control information. The communication control module 102 executes, for example, network processing (i.e., frame transmission processing and frame reception processing) that conforms to the Time-Sensitive Networking (TSN) standard defined in IEEE 802.1. TSN is a network standard that can ensure real-time performance.

The communication transfer module 103 outputs, for example, the frames received by the communication module 101 via the communication control module 102, to the different communication module 101 via the communication control module 102. The number of frame output destinations may be one or more. In addition, the communication transfer module 103 may determine the communication module 101 to which the frames are to be output, in accordance with destination information such as destination MAC addresses of the received frames, using a database referred to as Filtering Database or Forwarding Database (FDB). Alternatively, the frames may be transferred using destination MAC address information at the Layer 2 level or packets may be transferred using IP address information at the Layer 3 level.

The operation control information receiving module 104 receives a request for setting the first operation control information from the orchestration device via the communication modules 101 and the communication control module 102.

The operation control information setting module 105 sets the first operation control information, whose setting request has been received by the operation control information receiving module 104, in the communication transfer device 10. The first operation control information set by the operation control information setting module 105 is referenced by the above-described communication control module 102 to control the operations of the communication transfer device 10.

Incidentally, some or all of the modules 101 to 105 shown in FIG. 2 may be realized by the computer of the communication transfer device 10 executing a predetermined program (i.e., software), by hardware, or by a combination of software and hardware.

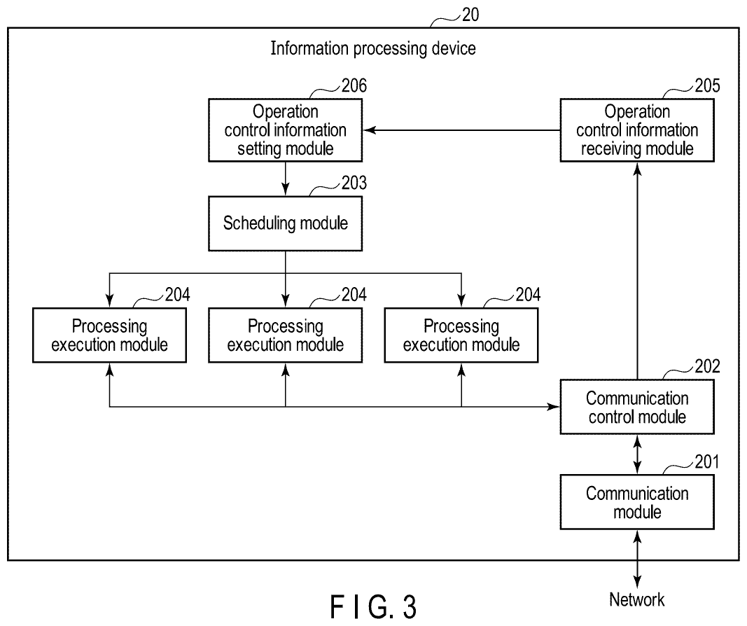

FIG. 3 shows an example of the functional configuration of the information processing device in the comparative example of the present embodiment. It has been described above that the network processing conforming to the TSN standard is executed in the communication transfer device 10. The information processing device 20 is assumed to be realized as an electronic device (for example, a personal computer) or the like into which a network card conforming to the TSN standard is inserted.

As shown in FIG. 3, the information processing device 20 includes a communication module 201, a communication control module 202, a scheduling module 203, a processing execution module 204, an operation control information receiving module 205, and an operation control information setting module 206.

The communication module 201 receives, for example, the frames transmitted (transferred) from the communication transfer device 10 which is capable of communicating with the information processing device 20. The frames transmitted from the communication transfer device 10 include, for example, device data obtained at the edge device 2.

In addition, the communication module 201 receives the frames transmitted from the orchestration device. The frames transmitted from the orchestration device include second operation control information generated by the orchestration device.

Although a single communication module 201 is shown for convenience in FIG. 3, the communication module 201 is provided for each communication port of the information processing device 20. More specifically, the information processing device 20 includes, for example, a communication module 201 corresponding to a communication port connected to the communication transfer device 10, a communication module 201 corresponding to a communication port connected to the orchestration device, and the like.

The communication control module 202 controls communication with the communication transfer device 10 and the orchestration device via the above-described communication modules 201. The communication control module 202 executes network processing conforming to the above-described TSN standard.

The scheduling module 203 controls the operations of the information processing device 20, based on the second operation control information. More specifically, the scheduling module 203 schedules the processing to be executed by the processing execution module 204. Incidentally, the processing executed by the processing execution module 204 is, for example, processing corresponding to an application operating on the information processing device 20 and includes computational processing using the above-described device data.

The processing execution module 204 is provided to correspond to, for example, each core included in the CPU (processor or host processor) provided in the information processing device 20. The processing execution module 204 executes processing, for example, in units of virtual machines.

Incidentally, the (frames including) results of the processing executed by the processing execution module 204 are transmitted to the communication transfer device 10 which is capable of communicating with the information processing device 20, via the communication control module 202 and the communication module 201.

The operation control information receiving module 205 receives a request for setting the second operation control information from the orchestration device via the communication module 201 and the communication control module 202.

The operation control information setting module 206 sets the second operation control information whose setting request has been received by the operation control information receiving module 205, in the information processing device 20. The second operation control information set by the operation control information setting module 206 is referenced by the above-described scheduling module 203 to control the operations of the information processing device 20.

In this example, the operation control information receiving module 205 can also receive a request for setting the first operation control information from the orchestration device, and the operation control information setting module 206 may set the first operation control information in the information processing device 20. In this case, the first operation control information is referenced by the communication control module 202 to control the operations of the information processing device 20.

Incidentally, some or all of the modules 201 to 206 shown in FIG. 3 may be realized by the computer of the information processing devices 20 executing a predetermined program (i.e., software), by hardware, or by a combination of software and hardware.

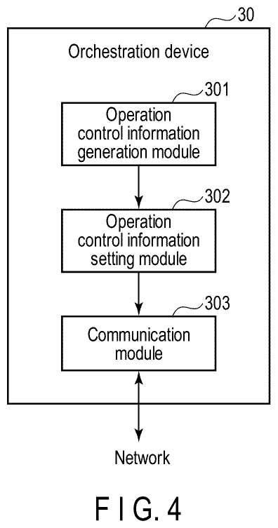

FIG. 4 shows an example of the functional configuration of the orchestration device in the comparative example of the present embodiment. Although omitted in FIG. 1, the orchestration device is communicably connected with the plurality of communication transfer devices 10 and the plurality of information processing devices 20, in the comparative example of the present embodiment.

As shown in FIG. 4, the orchestration device 30 includes an operation control information generation module 301, an operation control information setting module 302, and a communication module 303.

The operation control information generation module 301 generates the first operation control information in which the operations of the communication transfer device 10 are specified and the second operation control information in which the operations of the information processing device 20 are specified. Incidentally, the first operation control information is generated when, for example, the first operation control information is not set for the plurality of communication transfer devices 10. Similarly, the second operation control information is generated when, for example, the second operation control information is not set for the plurality of information processing devices 20. Furthermore, the first and second operation control information may be generated when the first and second operation control information need to be reset in a case where, for example, a new application is added to the information processing device 20. In the comparative example of the present embodiment, the first and second operation control information is generated based on delays in network processing and computational processing, and the like, which are determined by, for example, an administrator of the orchestration device 30, or the like.

The operation control information setting module 302 requests the communication transfer device 10 to set, for example, the first operation control information generated by the operation control information generation module 301. In addition, the operation control information setting module 302 also requests the information processing device 20 to set, for example, the second operation control information generated by the operation control information generation module 301.

The communication module 303 transmits (the frames including) the first operation control information to the communication transfer device 10 in response to the request from the operation control information setting module 302. In addition, the communication module 303 transmits (the frames including) the second operation control information to the information processing devices 20 in response to the request from the operation control information setting module 302.

Although a single communication module 303 is shown for convenience in FIG. 4, the communication module 303 is provided for each communication port of the orchestration device 30. More specifically, the orchestration device 30 includes, for example, a communication module 303 corresponding to a communication port connected to the communication transfer device 10, a communication module 303 corresponding to a communication port connected to the information processing device 20, and the like.

Incidentally, some or all of the modules 301 to 303 shown in FIG. 4 may be realized by the computer of the orchestration device 30 executing a predetermined program (i.e., software), by hardware, or by a combination of software and hardware.

The first and second operation control information generated by the above-described orchestration device will be described below.

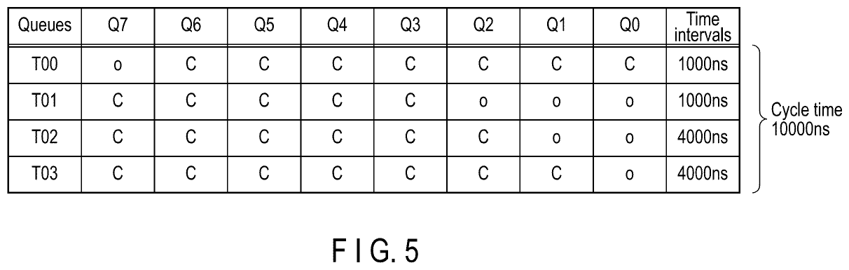

First, the first operation control information in which the operations of the communication transfer device 10 are specified will be described with reference to FIG. 5.

Examples of the TSN processing executed by the communication control module 102 include Enhancements for Scheduled Traffic (EST) and Per-Stream Filtering and Policing (PSFP) defined in IEEE 802.1Q. In the processing, the transmission and reception of frames can be controlled by opening and closing gates corresponding to the respective communication modules 101 associated with the communication ports. This gate opening and closing operation (gate control) is executed based on gate control information (gate control list).

FIG. 5 shows an example of the gate control information. Incidentally, in the gate control information, the opening and closing of the gates corresponding to each of the plurality of queues in which frames to be transmitted or received are stored are set.

In the gate control information shown in FIG. 5, the opening and closing states of the gates corresponding to four entries (slots) from “T00” to “T03” and eight queues from “Q0” to “Q7” (hereinafter referred to as queue gate states) are set. Incidentally, the queues “Q0” to “Q7” correspond to eight traffic classes, respectively. Incidentally, in FIG. 5, for example, queue “Q7” corresponds to the traffic class with the highest priority, and queue “Q0” corresponds to the traffic class with the lowest priority.

The gate state of each queue set for the opening/closing state of each gate is represented by “o” and “C”. “o” means that the gate is open. “C” means that the gate is closed. When the gate is open, transmission in the queue (transmission of frames stored in the queue) is permitted. In contrast, when the gate is closed, transmission in the queue is not permitted. In other words, according to this gate control information, it is possible to control the system such that the frames are allowed to pass when the queue gate is open (open state) and are not allowed to pass when the queue gate is closed (closed state). In other words, the transfer start timing (output start timing) of the frames stored in the queues can be controlled by referencing the gate control information.

In addition, in the gate control information, a time interval representing the duration for which the gate control corresponding to each entry is maintained is set (i.e., the opening and closing of the gate corresponding to each queue are set at time intervals). More specifically, it is shown in FIG. 5 that a time interval corresponding to entry “T00” is set to 1,000 ns. In this case, the gate control corresponding to entry “T00” (gate state corresponding to queues “Q0” to “Q7”) continues for 1000 ns.

According to the gate control information shown in FIG. 5, each entry is switched to the next entry according to the time interval corresponding to this entry. For example, when the time interval corresponding to entry “T00” elapses, entry “T00” is switched to entry “T01”. When the entry is switched in this manner, the gate states of queues “Q0” to “Q7” are also switched accordingly.

More specifically, queues “Q0” to “Q6” are closed and queue “Q7” is open during the time interval corresponding to entry “T00”. When entry “T00” is switched to entry “T01”, queues “Q3” to “Q7” are closed and queues “Q0” to “Q2” are opened during the time interval corresponding to entry “T01”. When entry “T02” and subsequent entries are switched in this manner, the gate states of the queues are also switched accordingly.

Incidentally, when the cycle time of 10,000 ns elapses, one cycle of gate control is completed, the entries return to the first entry (“T00” in the example of FIG. 5), and gate control is repeated.

The above-described gate control information is an example of the first operation control information in which the operations of the communication transfer device 10 are specified.

As described above, the communication control module 102 included in the communication transfer device 10 in the comparative example of the present embodiment can control the operations of the communication transfer device 10 (network processing for transferring the frames) based on the gate control information (first operation control information).

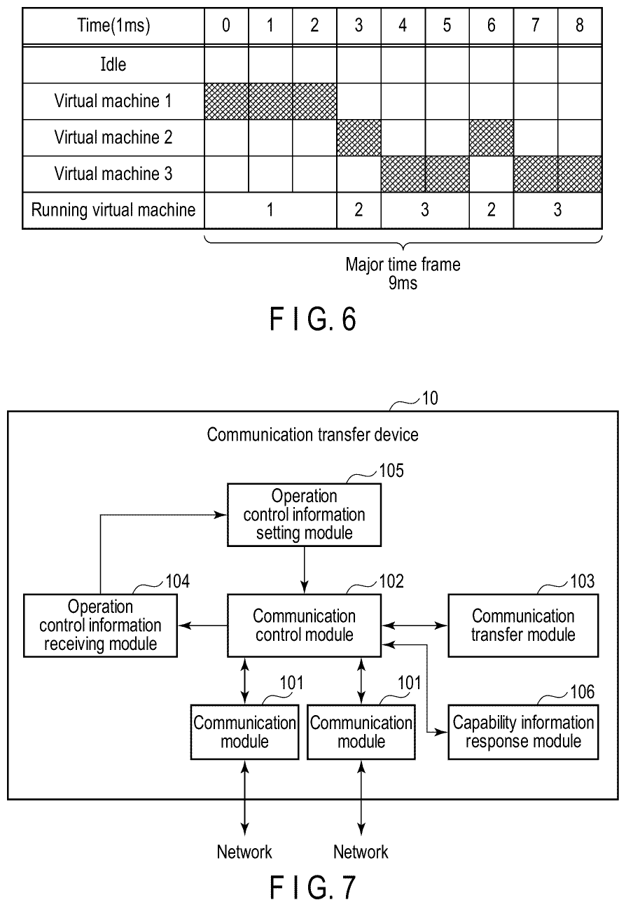

Next, the second operation control information in which the operations of the information processing device 20 are specified will be described with reference to FIG. 6.

It will be described here that a plurality of virtual machines executing the information processing using virtualization software or a hypervisor are assumed to be executed in the information processing device 20 and that the scheduling of the execution of each of the plurality of virtual machines is executed based on scheduling information. Incidentally, the scheduling information is information that indicates the schedule for executing the processing in units of virtual machines by the processor (for example, the processing execution module 204 realized by the CPU core) of the information processing device 20.

FIG. 6 shows an example of the scheduling information. There are various scheduling methods. Use of ARINC 653 scheduling method is assumed here.

In the ARINC 653 scheduling method, major time frames and minor time frames are used, and the major time frames have a structure including at least one minor time frame.

In the example shown in FIG. 6, a major time frame with a length of 9 ms is defined, and execution of three virtual machines 1 to 3 is defined as minor time frames. In FIG. 6, hatched areas indicate the time at which each virtual machine (processing) is executed.

Incidentally, FIG. 6 shows an example that each minor time frame is assigned 1 ms, for convenience. In the major time frame, the time allocated to the minor time frame (i.e., the execution time of the minor time frame) can be freely specified at an offset from the start timing of the major time frame. In the following descriptions, division of the execution time of the minor time frame (i.e., the length of the minor time frame) is referred to as a time slot.

By referring to such scheduling information, scheduling of executing virtual machines 1 to 3 in each time slot (minor time frame) can be repeated with the major time frame composed of time slots “0” to “8” as one cycle.

The above-described scheduling information is an example of the second operation control information in which the operations of the information processing device 20 are specified.

As described above, the scheduling module 203 included in the information processing device 20 in the comparative example of the present embodiment can control the operations of the information processing device 20 (computational processing for controlling the edge device 2), based on the scheduling information (second operation control information).

Incidentally, the scheduling information is assumed to be supplied to each of the processing execution modules 204 included in the information processing device 20. In addition, if the units of execution of the application program running on the information processing device 20 are considered as processes, the scheduling information can be described as information in which the schedule (task schedule) for each CPU core (the processing execution module 204 realized by this core) to execute the computational processing in units of process is defined.

In addition, the scheduling information has been conceptually described in FIG. 6. The scheduling information is assumed to include the start time of the major time frame, the length of the major time frame, the start offset of each minor time frame (offset from the start position of the major time frame), the length of the minor frame (length of the time slot), and the correspondence between the virtual machines whose execution is defined in each minor time frame. Incidentally, as shown in FIG. 6, for example, an idle (state) for waiting for the execution of the virtual machines may be defined in the minor time frame.

The gate control information has been described as the first operation control information in which the operations of the communication transfer device 10 are specified, and the scheduling information has been described as the second operation control information in which the operations of the information processing device 20 are specified. However, periodic operations and control operations are considered to be defined in the operation control information in the present embodiment.

The periodic operation is an operation (processing) executed for one cycle based on the operation control information. The periodic operation in the communication transfer device 10 is, for example, an operation for executing the gate control corresponding to all the entries included in the gate control information shown in FIG. 5, and corresponds to an operation executed in the cycle time. In addition, the periodic operation in the information processing device 20 is, for example, an operation for executing the virtual machines defined in all of the minor time frames in the scheduling information shown in FIG. 6, and corresponds to an operation executed during the length of the major time frame.

The control operations are operations (processing) executed during the periodic operations. The control operation in the communication transfer device 10 is, for example, an operation for executing the gate control corresponding to one entry included in the gate control information shown in FIG. 6, and corresponds to an operation executed during the time interval corresponding to the entry. In addition, the control operation in the information processing device 20 is, for example, an operation for executing the virtual machines defined in one minor time frame in the scheduling information shown in FIG. 6, and corresponds to an operation executed during the time (time interval between time slots) allocated to the minor time frame.

In addition, the operation control information is assumed to include the periodic operation time and the control operation time. The periodic operation time is the time during which the above-mentioned periodic operation is executed, and corresponds to the cycle time included in the gate control information and the length of the major time frame included in the scheduling information. In addition, the control operation time is the time allocated to the above-mentioned control operation, and corresponds to the time interval included in each entry in the gate control information and to the time interval of each time slot included in the scheduling information (the time allocated to the minor frame).

Incidentally, a case where, for example, in a control system 1 in which a robot arm installed in a factory in a manufacturing industry is an edge device 2, the robot arm is controlled to process products and the like transported by a belt conveyor is assumed. In such a control system 1, since it is necessary to control the robot arm such that automatically transported products can be processed within a specified time, the real-time performance is considered necessary.

When the information processing devices 20 are realized as edge clouds as described above, the edge clouds are located within, for example, sites of the factories or the like where the edge devices 2 are installed. Therefore, the edge clouds have a lower latency as compared to a public cloud located externally, and are considered suitable for real-time processing (processing requiring the real-time performance). Incidentally, such real-time processing is realized by the operation of application programs corresponding to the edge devices 2, which are control targets on the edge clouds, and include network processing and computational processing executed to control the edge devices 2. Furthermore, if the edge devices 2 are controlled using the edge clouds (information processing devices 20), the network processing included in the real-time processing includes network processing (upstream) for transferring the frames from the edge devices 2 to the edge clouds, and network processing (downstream) for transferring the frames from the edge clouds to edge devices 2.

As regards the edge clouds, however, installation and operational costs are higher than those of public clouds. In control system 1, the plurality of edge devices 2 may be controlled. If a control system 1 is constructed such that an application program corresponding to a single edge device 2 operates on a single edge cloud, a plurality of edge clouds need to be installed, resulting in the increase in costs for constructing and operating the control system 1. For this reason, it is necessary to suppress the number of edge clouds installed in the control system 1 by efficiently operating each of the edge clouds (i.e., enabling more application programs to run on the edge cloud).

In contrast, if a plurality of application programs are run on a single edge cloud, the processing corresponding to a specific application program may cause delays in processing corresponding to the other application programs, which may not enable the above-described real-time performance to be ensured.

Therefore, in the present embodiment, a mechanism is provided which ensures the real-time performance while improving the application program capacity in edge clouds (increasing the number of application programs running on the edge clouds) to efficiently operate the control system 1.

The communication transfer device 10, the information processing device 20, and the orchestration device 30 provided in the control system 1 according to the present embodiment will be described below.

FIG. 7 shows an example of the functional configuration of the communication transfer device 10 in the present embodiment. In FIG. 7, the same reference numerals are assigned to the same modules as those in FIG. 2, and their detailed descriptions are omitted. The modules different from those in FIG. 2 will be mainly described here.

As shown in FIG. 7, the communication transfer device 10 includes a capability information response module 106 in addition to the communication module 101, the communication control module 102, the operation control information receiving module 104, and the operation control information setting module 105 described in FIG. 2.

The capability information response module 106 receives inquiries from the orchestration device 30 via the communication module 101 and the communication control module 102.

The communication transfer device 10 executes, for example, the network processing such as transferring frames as the processing for controlling the edge device 2. When the inquiries from the orchestration device 30 are received, the capability information response module 106 generates capability information indicating the processing capability on the network processing. Incidentally, the capability information generated by the capability information response module 106 in this manner is considered to be information indicating the capability of the communication transfer device 10, which can be provided to the control system 1 during the execution of the network processing by the communication transfer device 10.

The capability information generated by the capability information response module 106 as described above is transmitted to the orchestration device 30 via the communication control module 102 and the communication module 101, as a response to the inquiries from the orchestration device 30.

Incidentally, some or all parts of the capability information response module 106 shown in FIG. 7 may be realized by the computer of the communication transfer device 10 executing a predetermined program (i.e., software), by hardware, or by a combination of software and hardware.

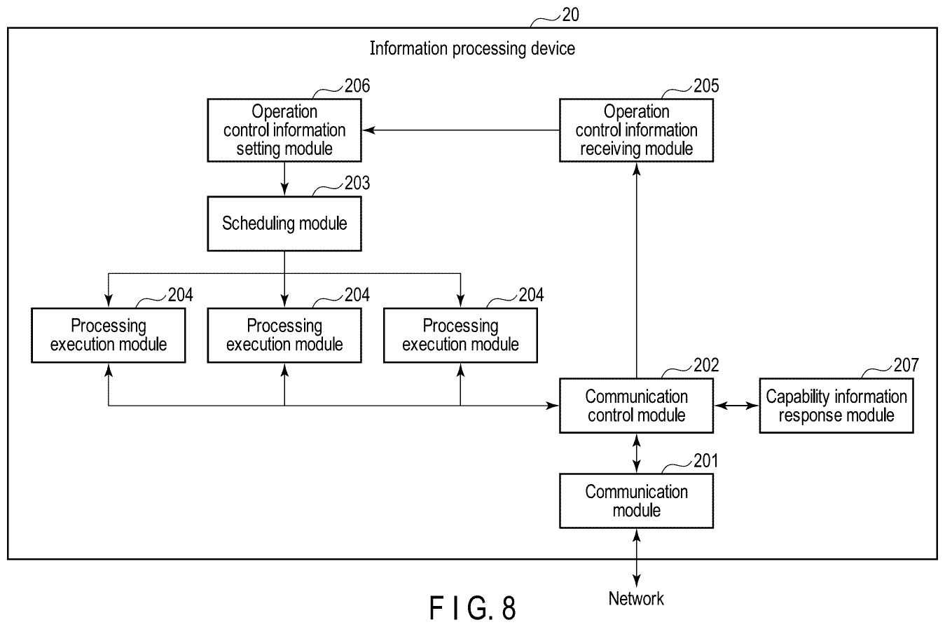

FIG. 8 shows an example of the functional configuration of the information processing device 20 in the present embodiment. In FIG. 8, the same reference numerals are assigned to the same modules as those in FIG. 3, and their detailed descriptions are omitted. The modules different from those in FIG. 3 will be mainly described here.

As shown in FIG. 8, the information processing device 20 includes a capability information response module 207 in addition to the communication module 201, the communication control module 202, the scheduling module 203, the processing execution module 204, the operation control information receiving module 205, and the operation control information setting module 206 described in FIG. 3.

The capability information response module 207 receives inquiries from the orchestration device 30 via the communication module 201 and the communication control module 202.

The information processing device 20 executes, for example, computational processing using the device data as the processing for controlling the edge device 2. When the inquiries from the orchestration device 30 are received, the capability information response module 207 generates capability information indicating the processing capability on the computational processing. Incidentally, the capability information generated by the capability information response module 207 in this manner is considered to be information indicating the capability of the information processing devices 20, which can be provided to the control system 1 during the execution of the computational processing by the information processing devices 20.

The capability information generated by the capability information response module 207 as described above is transmitted to the orchestration device 30 via the communication control module 202 and the communication module 201, as a response to the inquiries from the orchestration device 30.

Incidentally, some or all parts of the capability information response module 207 shown in FIG. 8 may be realized by the computer of the information processing devices 20 executing a predetermined program (i.e., software), by hardware, or by a combination of software and hardware.

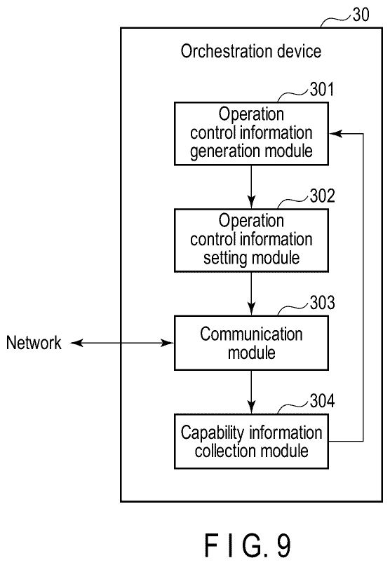

FIG. 9 shows an example of the functional configuration of the orchestration device 30 in the present embodiment. In FIG. 9, the same reference numerals are assigned to the same modules as those in FIG. 4, and their detailed descriptions are omitted. The modules different from those in FIG. 4 will be mainly described here.

As shown in FIG. 9, the orchestration device 30 includes a capability information collection module 304 in addition to the operation control information generation module 301, the operation control information setting module 302, and the communication module 303 described in FIG. 4.

The capability information collection module 304 makes inquiries on the capabilities of the communication transfer device 10 and the information processing device 20 (processing capabilities on the network processing and the computational processing) via the communication module 303.

The capability information collection module 304 collects the capability information, which is the response to the inquiries made by the capability information collection module 304, from the communication transfer device 10 and the information processing device 20 via the communication module 303.

In the present embodiment, the capability information collected by the capability information collection module 304 is passed to the operation control information generation module 301, and the operation control information generation module 301 generates the first and second operation control information, based on the capability information passed from the capability information collection module 304.

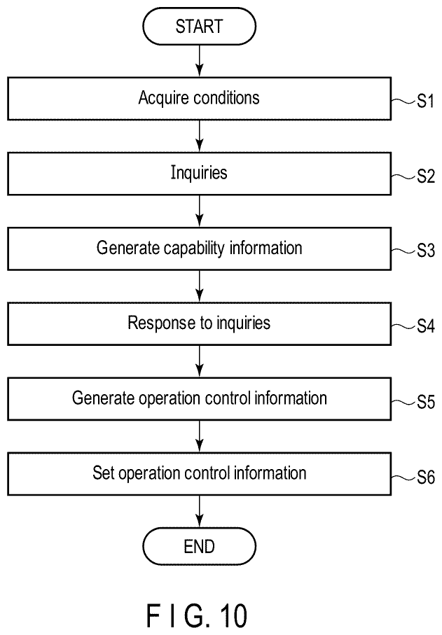

The operations of the communication system 1 according to the present embodiment will be described below. The processing for generating the first and second operation control information will be described with reference to a flowchart of FIG. 10.

When the first and second operation control information is generated as described above, the capability information collection module 304 included in the orchestration device 30 acquires the conditions for each application, which are specified in relation to the processing (for example, real-time processing) for controlling the edge device 2 executed in the control system 1 (step S1). Incidentally, the conditions acquired in step S1 are conditions for collecting capability information. For example, the conditions for each application may be registered in advance in the memory (not shown) of the orchestration device 30 by the user or the conditions may be acquired dynamically from the application to be operated. In addition, in step S1, for example, different conditions are acquired by the communication transfer device 10 and the information processing device 20.

Next, the capability information collection module 304 makes inquiries to the communication transfer device 10 and the information processing device 20 (step S2). In step S2, an inquiry regarding the processing capability of the network processing is made for the communication transfer device 10, and an inquiry regarding the processing capability of the computational processing is made for the information processing device 20. Incidentally, the inquiries in step S2 are made by sending frames (hereinafter referred to as inquiry frames) including the above-described conditions acquired in step S1 from the orchestration device 30 (communication module 303) to the communication transfer device 10 and the information processing device 20.

When the processing in step S2 is executed, the communication transfer device 10 and the information processing device 20 receive the inquiry frames sent from the orchestration device 30 for the purpose of making the inquiries in step S2, and generate capability information in response to the inquiries (step S3).

The capability information generated in step S3 will be described below in detail. First, when an inquiry is made to the communication transfer device 10, the inquiry frame transmitted from the orchestration device 30 is received by the communication module 101 included in the communication transfer device 10. The capability information response module 106 acquires the inquiry frame via the communication control module 102, thereby receiving the inquiry from the orchestration device 30.

In this case, the capability information response module 106 extracts the conditions specified for the processing to control the edge device 2 from the inquiry frame and generates capability information indicating the capability of the communication transfer device 10 that can be provided under those conditions.

The conditions included in the inquiry frames transmitted from the orchestration device 30 to make inquiries on the communication transfer device 10 are conditions specified for the network processing to be executed in the communication transfer device 10, and are assumed to include, for example, a frame length of the frame (hereinafter referred to as a target frame) to be transferred in the network processing. The maximum value or minimum value of the frame length used by the application to be added may be used as the frame length.

In addition, the conditions may include, for example, the transmission cycle of a specific frame, the maximum value of the transmission cycle, and the minimum value of the transmission cycle, as information on the transmission cycle (transmission interval) of frames.

Furthermore, the conditions may also include a value of a specific transmission rate, the maximum value of the transmission rate, and the minimum value of the transmission rate, as information on the transmission rate of frames.

Furthermore, the conditions include setting type information indicating whether to add a new target application while retaining existing settings (add) or to discard existing settings and add a new target application (new).

If the communication transfer device 10 is assumed to transfer the target frames based on such conditions (for example, frames with the maximum value of the frame length of 100 bytes), the delay (hereinafter referred to as network processing delay) that occurs when the target frames are transferred can be considered as an index indicating the processing capability of the communication transfer device 10 on the network processing, and is influenced by the resources (i.e., network resources) of the communication transfer device 10 available for use in the network processing.

In addition, in the present embodiment, since the operations of the communication transfer device 10 are controlled based on the above-described first operation control information, the first operation control information can be considered to be information in which the network resources of the communication transfer device 10 used for network processing are defined.

Therefore, in the present embodiment, the capability information response module 106 is assumed to generate capacity information including the network processing delay, based on the network resources of the communication transfer device 10, which are defined in the first operation control information.

More specifically, if it is assumed that the first operation control information is the gate control information described above with reference to FIG. 5, the gate state of each queue is set in the plurality of slots in the gate control information. In this case, regarding a predetermined queue, if the period (time) during which the gate state of the queue is “C” is increased (extended) (i.e., the number of slots in which the gate state of the queue is “o” is reduced), the frames stored in the queue cannot be transmitted while the gate state is closed. As a result, the frames are transmitted at long intervals and the network processing delay becomes large. In contrast, regarding the predetermined queue, if the period (time) during which the gate state of the queue is “C” is reduced (shortened) (i.e., the number of slots in which the gate state of the queue is “o” is increased), the frames stored in the queue are transmitted at short intervals and the network processing delay becomes small. Therefore, the capability information response module 106 can generate the capability information including the maximum and minimum values of the network processing delay, which are calculated based on information on a plurality of slots included in the gate control information (for example, the number of slots, time intervals, and the like). In this example, the maximum value refers to the maximum value within the range where delay can be assured. The capability information generated by the capability information response module 106 may be the information including either the maximum value or the minimum value of the network processing delay.

Incidentally, the network processing delay in the present embodiment may include the delay caused when the frame passes through the gate, in addition to the delay caused by the frame transfer start timing controlled based on the gate control information (first operation control information) as described above.

It has been described that the capability information indicating the processing capability of the communication transfer device 10 in relation to the network processing (hereinafter referred to as capability information of the communication transfer device 10) is generated based on the first operation control information (for example, information on the plurality of gate states and time intervals of the gate control information). However, the capability information of the communication transfer device 10 may be generated based on the other information. More specifically, the capability information of the communication transfer device 10 may be generated based on, for example, (information on) the network bandwidth allocated to each communication port of the communication transfer device 10.

In addition, when an inquiry is made to the information processing device 20, the inquiry frame transmitted from the orchestration device 30 is received by the communication module 201 included in the information processing device 20. The capability information response module 207 receives the inquiry from the orchestration device 30 by acquiring the inquiry frame via the communication control module 202.

In this case, the capability information response module 207 extracts the conditions specified for the processing to control the edge device 2 from the inquiry frame and generates the capability information indicating the capability of the information processing device 20 that can be provided under the specified conditions.

In this example, the conditions included in the inquiry frame transmitted from the orchestration device 30 to inquire about the information processing device 20 are assumed to be the conditions specified for the computational processing to be executed by the information processing device 20 and to include, for example, the number of processes corresponding to the units of execution of the application program (hereinafter referred to as a target program) running on the information processing device 20 to execute the computational processing.

If the information processing device 20 is assumed to execute the computational processing in accordance with each process of the target program based on such conditions, the delay that occurs when the computational processing is executed (hereinafter referred to as computational processing delay) can be considered as an index indicating the processing capability of the information processing device 20 in relation to the computational processing, and is influenced by the resources (i.e., computational resources) of the information processing device 20, which can be used for the computational processing.

Furthermore, in the present embodiment, since the operation of the information processing device 20 is controlled based on the above-described second operation control information, the second operation control information can be considered to be information in which the computational resources of the information processing device 20 used for computational processing are defined.

Therefore, in the present embodiment, the capability information response module 207 is assumed to generate the capability information including the computational processing delay, based on the computational resources of the information processing device 20, which are defined in the second operation control information.

By the way, in general, a CPU is used in core units included in the CPU, and each core is used as a dedicated core or a shared core. Incidentally, the dedicated core is, for example, a core used exclusively for frame processing which requires the real-time performance. In this core, only one or more target programs that require real-time performance are executed. In contrast, the shared core is a core shared by the target programs executing the frame processing which does not require the real-time performance. The information indicating which target program (process or virtual machine) is executed in which core is referred to as scheduling information, which is the second operation control information in the present invention.

Furthermore, when a single dedicated core is shared by a plurality of applications (processes or virtual machines), the core is controlled by scheduling information as shown in FIG. 6, which is strictly divided in time. This scheduling information corresponds to a scheduling method for realizing the real-time performance, and it is assumed that a single dedicated core is shared among the plurality of virtual machines (i.e., the processing execution module 204 executes processing in units of virtual machines). This also corresponds to the second operation control information. In this case, when the number of time slots in which computational processing is executed according to the target program is reduced (i.e., the number of time slots in which the computational processing is not executed is increased), the computational processing is executed at a slow speed and the computational processing delay becomes large. In contrast, when the number of time slots in which computational processing is executed according to the target program is increased (i.e., the number of time slots in which the computational processing is not executed is reduced), the computational processing is executed at a high speed and the computational processing delay becomes small. Therefore, the capability information response module 207 can generate the capability information including the maximum and minimum values of the computational processing delay calculated based on the schedule indicated by the scheduling information (the schedule in which each core of the CPU executes the computational processing in units of processes). The capability information generated by the capability information response module 207 may include information including either the maximum or minimum value of the computational processing delay.

Incidentally, the computational processing delay in the present embodiment may include the delay caused by frame reception processing used for the computational processing and frame transmission processing including the computational processing results in addition to the delay caused by the computational processing controlled based on the scheduling information (second operation control information) as described above.

In this example, it has been described that the capability information indicating the processing capability of the information processing device 20 in relation to the computational processing (hereinafter referred to as capability information of the information processing device 20) is generated based on the second operation control information (for example, a schedule in which a plurality of cores execute computational processing in units of processes as indicated by the scheduling information). However, the capability information of the information processing device 20 may be generated based on the other information. More specifically, according to the above-described scheduling information, the utilization status of the CPU (one core) provided in the information processing device 20 can be determined. However, the capability information of the information processing device 20 may be generated based on, for example, the number of plurality of cores or the number of unused cores. Alternatively, the capability information of the information processing device 20 may be generated based on the number of dedicated cores or shared cores as described above. Furthermore, the capability information of the information processing device 20 may be generated based on, for example, the execution time (i.e., computational processing delay) measured when each of the cores included in the CPU provided in the information processing device 20 actually executes the computational processing in accordance with each process of the target program.

When the process of step S3 is executed as described above, the capability information generated in step S3 is transmitted from the communication transfer device 10 and the information processing device 20 to the orchestration device 30 as the response to the inquiries made in step S2 (step S4).

In the present embodiment, the above-described processes of steps S2 to S4 are executed for each of the plurality of communication transfer devices 10 and the plurality of information processing devices 20. According to this, the capacity information collection module 304 included in the orchestration device 30 can collect the capacity information of each of the plurality of communication transfer devices 10 and the capacity information of each of the plurality of information processing devices 20 via the communication module 303. Thus, the capability information collected by the capability information collection module 304 is passed to the operation control information generation module 301.

Next, the operation control information generation module 301 generates the first and second operation control information, based on the capability information passed from the capability information collection module 304 (step S5).

The process in step S5 will be described here. If it is assumed that the real-time processing is executed (i.e., the edge device 2 is controlled in real time) in the control system 1 according to the present embodiment, the control system 1 needs to operate such that a response necessary for controlling the edge device 2 is obtained within at least a range which does not exceed the control cycle of the edge device 2 (i.e., the response time is shorter than the control cycle).

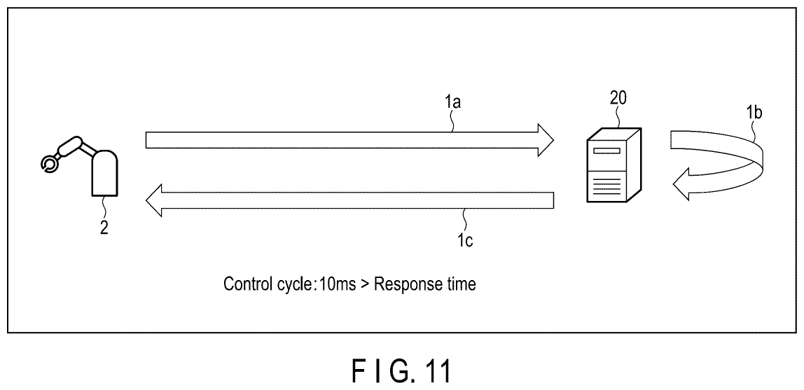

More specifically, it is assumed that, as shown in, for example, FIG. 11, when a predetermined application program is executed on the information processing device 20, the computational processing is executed using the device data transmitted from the edge device 2, and the edge device 2 is controlled based on the result of the computational processing. In this case, the response time required to achieve the above-described control of the edge device 2 is equal to the sum of the network processing time (upstream) 1a required to transmit (the frames including) the device data from the edge device 2 to the information processing device 20, the computational processing time 1b required to execute the computational processing on the information processing device 20, and the network processing time (downstream) 1c required to transmit the result of the computational processing (including frames) from the information processing device 20 to the edge device 2. Incidentally, the network processing time includes the time required for the plurality of communication transfer devices 10 to transfer the frames between the edge device 2 and the information processing device 20.

Generally, the time allocated to each section (network processing time 1a, computational processing time 1b, and network processing time 1c) is determined by an administrator (orchestrator) of the orchestration device 30. In the present embodiment, the first and second operation control information is generated based on the capability information of the communication transfer device 10 and the information processing device 20 such that the above-described response time (network processing time 1a+computational processing time 1b +network processing time 1c) is smaller than, for example, a control cycle (for example, 10 ms) preset in the control system 1.

More specifically, the capability information of the communication transfer device 10 is information indicating the processing capability of the communication transfer device 10 in relation to the network processing, and is assumed to include, for example, the maximum and minimum values (i.e., the range of the network processing delays) that can ensure the above-described network processing delay. In addition, the capability information of the information processing devices 20 is information indicating the processing capability of the information processing devices 20 in relation to the computational processing, and is assumed to include, for example, the maximum and minimum values (i.e., the range of the computational processing delays) that can ensure the above-described computational processing delay.

According to this, for example, when it is determined that the network processing delay cannot be reduced based on the capability information of the communication transfer device 10 (i.e., there is no spare in the network resource and there are few surplus resources), the operation control information generation module 301 can generate the second operation control information which reduces the computational processing delay to the degree of ensuring the real-time performance.

In addition, for example, when it is determined that the computational processing delay cannot be reduced based on the capability information of the information processing devices 20 (i.e., there is no spare in the computation resource and there are few surplus resources), the operation control information generation module 301 can generate the first operation control information which reduces the network processing delay to the degree of ensuring the real-time performance.

Incidentally, since the response time varies depending on the periodic operation time and the control operation time which are included in the above-described operation control information, the first and second operation control information may be generated by adjusting the periodic operation time and the control operation time such that the response time is shorter than the control cycle, in the present embodiment.

In step S5 mentioned above, the first operation control information is generated for each of the plurality of communication transfer devices 10, and the second operation control information is generated for each of the plurality of information processing devices 20.

When the process in step S5 is executed, a process to set the first and second operation control information generated in step S5 is executed (step S6).

In this case, the operation control information setting module 302 requests the communication transfer device 10 to set the first operation control information by transmitting the first operation control information to the communication transfer device 10 via the communication module 303. According to this, the operation control information reception module 104 included in the communication transfer device 10 receives a request for setting the first operation control information via the communication module 101 and the communication control module 102, and the operation control information setting module 105 sets the first operation control information in the communication transfer device 10.

Similarly, the operation control information setting module 302 requests the information processing device 20 to set the second operation control information by transmitting the second operation control information to the information processing device 20 via the communication module 303. According to this, the operation control information receiving module 205 included in the information processing device 20 receives a request for setting the second operation control information via the communication module 201 and the communication control module 202, and the operation control information setting module 206 sets the second operation control information in the information processing device 20.

By setting the first and second motion control information in this manner, the communication transfer device 10 and the information processing device 20 operate based on the first and second motion control information, thereby enabling the real-time performance in the control system 1 to be realized.

As described above, the communication transfer device 10 and the information processing device 20 according to the present embodiment generate the capability information indicating the capabilities of the communication transfer device 10 and the information processing device 20, which can be provided under specified conditions in relation to the processing for controlling the edge device 2 (for example, the network processing and the computational processing), and transmit the generated capability information. Incidentally, the communication transfer device 10 and the information processing device 20 according to the present embodiment receive the inquiries from the orchestration device 30 and transmit the capability information to the orchestration device 30 in response to the inquiries. According to this, the orchestration device 30 can set the operation control information in which the operations of the communication transfer device 10 and the information processing device 20 are specified, based on the capability information transmitted (collected) from the communication transfer device 10 and the information processing device 20.

In the present embodiment, with this configuration, it is possible to realize the efficient operation of the control system 1 while ensuring the real-time performance, by operating the communication transfer device 10 and the information processing device 20, based on the first and second operation control information corresponding to the processing capacity of the communication transfer device 10 in relation to the network processing and the processing capacity of the information processing device 20 in relation to the computational processing.

Incidentally, for example, in IEEE 802.1Q, a mechanism in which the communication transfer device 10 or the like responds to the delay to be actually ensured with respect to the delay specified by the administrator of the orchestration device 30 (the delay ensured by the administrator in control system 1). In such a mechanism, however, if the capability of the communication transfer device 10 (range of the network processing delay) is to be recognized in the orchestration device 30, in this system, repeated communication (inquiry) between the communication transfer device 10 and the orchestration device 30 needs to be established. In contrast, in the present embodiment, by providing an interface for collecting the capability information (for example, the network processing delay and the computational processing delay) from the communication transfer device 10 and the information processing device 20 as described above, the capability information of the communication transfer device 10 and the information processing device 20 can easily be collected via the interface.

Furthermore, in the present embodiment, it is possible to flexibly determine the processing time (i.e., delay amount) to be allocated to each section such as the network processing time (upstream), the computational processing time, and the network processing time (downstream), and generate the first and second operation control information, based on the capability information collected from the communication transfer device 10 and the information processing device 20. In other words, in the present embodiment, it is possible to flexibly change the operations of the communication transfer device 10 and the information processing device 20 by recognizing the surplus resource from the capability information.

According to such a configuration, it is considered possible to securing the surplus resource by efficiently using the resources of the communication transfer device 10 and the information processing device 20 within the range where the real-time performance can be ensured in the control system 1, and to further execute the other application programs on the information processing device 20 using the surplus resource.

In other words, in the present embodiment, since it is possible to increase the number of application programs that can be executed on an edge cloud which can achieve the real-time performance by processing at a location close to the user (i.e., to improve the application program capacity), the number of information processing devices 20 that are realized as the edge clouds can be suppressed and the operating costs of the edge clouds can be lowered.

Incidentally, it has been described that in the present embodiment, the capability information is collected from the communication transfer device 10 and the information processing device 20. However, these communication transfer device 10 and information processing device 20 are examples of control devices used in the control system 1 to control, for example, the edge device 2. The present embodiment may also be configured to collect the capability information from control devices different from the communication transfer device 10 and the information processing device 20. For example, the control device may be a device (function) referred to as Centralized Network Configuration (CNC) or Centralized User Configuration (CUC) defined in IEEE 802.1Q. Alternatively, the operation information of each device may be stored in advance in the orchestration device 30 to use this information to respond with the capability information of each device.

Furthermore, if it is assumed that the communication transfer device 10 executes the network processing for transferring the frames between the edge device 2 and the information processing device 20 as described above, the conditions specified for the network processing in the present embodiment include the frame length of the frame, and the capability information including the delay that occurs when the frame having the frame length is transferred is generated in the communication transfer device 10.

Incidentally, for example, the capability information of the communication transfer device 10 may be generated based on the information of a plurality of slots included in the gate control information, or may be generated based on the network bandwidth allocated to the communication transfer device 10.

In addition, as described above, if the information processing device 20 is assumed to execute the computational processing for controlling the edge device 2, the conditions specified for the computational processing in the present embodiment include the number of processes of the application program running on the information processing device 20 to execute the computational processing, and the capability information including the delay which occurs when the computational processing is executed according to each of the processes of the application program is generated in the information processing devices 20. In addition, the conditions may also include computation volume information indicating the computation processing volume. The computation volume information includes, for example, the number of program steps.

Incidentally, the capability information of the information processing device 20 may be generated based on, for example, a schedule in which a plurality of cores included in the CPU (processor) provided in the information processing device 20 execute the computational processing in units of processes or may be generated based on the number of cores. Furthermore, the number of cores used to generate the capability information of the information processing device 20 may be, for example, the number of dedicated cores (cores dedicated to the processing of the frames, which requires the real-time performance) or may be the number of shared cores (cores shared between the processing of the frames, which requires the real-time performance, and the processing of the frames, which does not require the real-time performance). Furthermore, the capability information of the information processing device 20 may be generated based on the execution time measured when each of the cores included in the CPU provided in the information processing device 20 executes the computational processing in accordance with each of the processes of the application program.

In addition, it has been described that, in the present embodiment, for example, the capacity information including the maximum and minimum values of delays (network processing delay and computational processing delay) is generated. However, the capacity information including the maximum and minimum values of delays may be collected from either the communication transfer device 10 or the information processing device 20. More specifically, for example, if the maximum and minimum values of the network processing delay are included in the capability information of the communication transfer device 10 and the computational processing delay is a fixed value, then the first operation control information for operating the communication transfer device 10 with the network processing delay which can achieve the real-time performance in accordance with the computational processing delay may be generated (set). In contrast, for example, if the network processing delay is a fixed value and the maximum and minimum values of the computational processing delay are included in the capability information of the information processing device 20, then the second operation control information for operating the information processing device 20 with the computational processing delay which can achieve the real-time performance in accordance with the network processing delay may be generated (set). Thus, in the present embodiment, for example, the operation control information in which the operations of one of the communication transfer device 10 and the information processing device 20 are specified may be generated based on the capability information of the other device.

Furthermore, in the present embodiment, if it is possible to generate the operation control information for efficiently operating the communication transfer device 10 and the information processing device 20 in the control system 1, the capability information including at least one of the maximum and minimum values of the delays may be generated.

In addition, the delays (network processing delay and computational processing delay) in the present embodiment are examples of an index indicating the capabilities of the communication transfer device 10 and the information processing device 20. In the present embodiment, the capability information including (at least either the maximum values or the minimum values of) other indices may be generated.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is

1. A control device for executing a process for controlling an edge device, the control device comprising:
a processor configured to:
generate capability information indicating capability of the control device, which can be provided under conditions specified in relation to the process, and
transmit the generated capability information.

2. The control device of claim 1, wherein
the capability information includes at least one of a maximum value and a minimum value of an index indicating the capability of the control device.

3. The control device of claim 2, wherein
the control device includes a communication transfer device executing network processing for transferring a frame between the edge device and an information processing device which executes computational processing for controlling the edge device,
the conditions include a frame length of the frame, and
the index includes a delay which occurs when the frame with the frame length is transferred.

4. The control device of claim 3, wherein
The processor is configured to, based on gate control information having a plurality of entries in which opening and closing of a gate corresponding to each of a plurality of queues is set at time intervals, control output start timing of a frame stored in the queue, and
the capability information is generated based on information on the opening and closing states and the time intervals of the gate, which are set in the gate control information.

5. The control device of claim 3, wherein
the capability information is generated based on a network bandwidth allocated to the communication transfer device.

6. The control device of claim 2, wherein
the control device includes an information processing device executing computational processing for controlling the edge devices,
the conditions include the number of processes of the program running on the information processing device to execute the computational processing, and
the index includes a delay which occurs when the computational processing is executed according to each of the processes of the program.

7. The control device of claim 6, wherein
the capability information is generated based on a schedule in which a plurality of cores included in a processor provided in the information processing device execute the computational processing in units of processes.

8. The control device of claim 6, wherein
the capability information is generated based on the number of cores included in a processor provided in the information processing device.

9. The control device of claim 8, wherein
the capability information is generated based on the number of cores dedicated to processing for which real-time performance is required.

10. The control device of claim 8, wherein
the capability information is generated based on the number of cores shared by processing for which a plurality of real-time performances are not required.

11. The control device of claim 6, wherein
the capability information is generated based on an execution time measured when each of cores included in the processor provided in the information processing device executes the computational processing in accordance with each of the processes of the program.

12. The control device of claim 1, wherein
the processor is configured to:
receive an inquiry from an orchestration device which is communicably connected to the control device;
generate the capability information in response to the received inquiry; and
transmit the generated capability information to the orchestration device as a response to the inquiry, and
the orchestration device is configured to generate operation control information in which an operation of the control device is specified, based on the transmitted capability information.

13. A control system comprising a control device executing processing for controlling an edge device and an orchestration device communicably connected to the control device, wherein
the orchestration device is configured to make an inquiry to the control device,
the control device is configured to generate, in response to the inquiry, capability information indicating capability of the control device that can be provided under conditions specified in relation to the processing, and transmit the generated capability information to the orchestration device as a response to the query, and
the orchestration device is configured to generate operation control information in which the operation of the control device is specified, based on the transmitted capability information.

14. A method executed by a control device executing processing for controlling an edge device, the method comprising:
generating capability information indicating capability of the control device, which can be provided under conditions specified in relation to the processing; and
transmitting the generated capability information.
